(19) United States
(12) Patent Application Publication
(10) Pub. No.: US 2010/0288941 A1
(43) Pub. Date: Nov. 18, 2010

(54) FLUORESCENCE-BASED PIPETTE INSTRUMENT

(76) Inventors: Harold E. Ayliffe, Salt Lake City, WA (US); Curtis S. King, Kirkland, WA (US)

Correspondence Address: BRIAN C. TRASK, 3601 EAST HERMES DRIVE, SALT LAKE CITY, UT, 84124, US

(21) Appl. No.: 12/744,134

(22) PCT Filed: Nov. 21, 2008
(86) PCT No.: PCT/US08/13003

§ 371 Date: May 21, 2010

Related U.S. Application Data
(60) Provisional application No. 61/004,630, filed on Nov. 27, 2007.

(51) Int. Cl. G01N 23/00

(52) U.S. Cl. 250/432 R

(57) ABSTRACT

An improved pipette tip (276) including an elongate body stretching between a proximal end (277) and a distal end. The body typically includes a plurality of thin film layers (e.g. 154, 156, 102, 158, 202) configured and arranged to provide a fluid path extending from the distal end toward the proximal end (277). The improved pipette tip (276) includes an interrogation zone in which to interrogate fluid flowing along the fluid path. One operable interrogation arrangement, generally (100), includes structure configured to permit detection of radiation resulting from a Stokes-shift. Optionally, a sensor component may include one or more electrode (e.g. 248, 250) that is disposed in the fluid path to contact fluid therein for electrically-based interrogation. A pipette tip (276) may be embodied to: count particles, verify sample integrity (e.g. freedom from bubbles), monitor sample flow rate, and confirm an inspired volume, among other uses.

### PRIORITY CLAIM

This application claims the benefit of the filing date of U.S. Provisional Patent Application Ser. No. 61/004,630, filed Nov. 27, 2007, for “Fluorescence-based pipette instrument”, the entire contents of which are incorporated herein by this reference.

### TECHNICAL FIELD

This invention relates to devices for extracting a fluid sample from a bulk fluid container for subsequent or simultaneous optical and/or electrical interrogation of the sample.

### BACKGROUND

Handheld pipettes, which are used for precision fluid volume measurement and delivery, are some of the most common and widely-used laboratory tools available to scientists today. Many procedures requiring low-volume fluid handling of biological and chemical liquid samples rely on their ease of use, precision and repeatability to ensure proper, consistent experimental processing. Commercial pipettes are available in a wide variety of fixed and adjustable volumes. When used in large-scale, high-throughput testing, commercially available pipettes are often multiple-channel, allowing for precise fluid metering of up to 12 different samples, simultaneously, with the single push of a button. Typical pipette instruments rely on positive displacement systems (e.g. either a manually operated plunger system, or an electronic pump) to generate the pressure required to urge a specified fluid volume into, or out of, a disposable pipette tip. Once the sample is ejected, the pipette tip is discarded. State-of-the-art pipette instruments are capable of accurately metering fluid volumes of less than 1 mL, and employ servo pumps for volume control and fluid metering. Digital displays with integrated electronic controls improve the pipette instrument's ease of use for the operator.

In the laboratory, pipettes are typically found in wet bench environments and are used in countless fluid-metering applications ranging from fluid mixing to sample isolation and preparation. In experimental cell biology, pipettes are routinely used to isolate small volume suspensions of cells in culture. In one of the most common procedures, manually counting (under microscope observation) a small portion of the cells in a precisely metered volume allows a user to make population and cell viability estimates for the entire volume of cells in culture. Unfortunately, counting cells under a microscope using this approach is very time and resource intensive, and count accuracy depends wholly on the number of cells a user is willing to actually count in the given volume.

Pioneering work in particle detection by measuring impedance deviation caused by particles flowing through a small aperture between two containers of electrically conductive fluids is disclosed in U.S. Pat. No. 2,656,508 to W. H, Coulter. The inventor's name is now associated with the principle of particles causing a change in electric impedance as they occlude a portion of the aperture. Since publication of his patent, considerable effort has been devoted to developing and refining sensing devices operating under the Coulter principle. Relevant US patents include U.S. Pat. Nos. 5,376,878 to Fisher; 6,703,819 to Gascoyne et al.; 6,437,551 to Krulevitch et al.; 6,426,615 to Mehta; 6,169,394 to Frazier et al.; 6,454,945 and 6,488,896 to Weigl et al.; 6,656,431 to Holl et al.; and 6,794,877 to Blomberg et al. All of the above-referenced documents are hereby incorporated by reference, as though set forth herein in their entireties, for their disclosures of technology and various sensor arrangements.

The ability of certain particles to emit radiation at a different frequency than an applied excitation frequency is commonly known as Stokes-shift. Recent US patents disclosing structure related to interrogation of such phenomena include: U.S. Pat. Nos. 7,450,238; 7,444,053; 7,420,674; 7,416,700; 7,312,867; 7,300,800; and 7,221,455. All of the above-referenced documents are hereby incorporated by reference, as though set forth herein in their entireties, for their disclosures of relevant technology and various sensor arrangements.

It would be an improvement to provide a precision fluid interrogation apparatus that is capable of metering very precise quantities of a bulk fluid to extract a fluid sample, and interrogating that sample (optically and/or electrically), to determine one or more characteristic of such sample, such as particle count per unit volume. It would be a further advance for the apparatus to be embodied as a low-cost, one-time-use, rugged, and disposable device.

### DISCLOSURE OF THE INVENTION

The present invention provides an apparatus and method for interrogating particles entrained in a fluid sample. Certain currently preferred embodiments may extract such sample from a bulk container of fluid. Currently preferred embodiments are operable to perform certain tests on one or more portion of the fluid sample, such as particle count per unit volume, and/or may verify a volumetric size or flow rate of the sample, or a portion thereof, among other functions. Tests, or interrogation, may encompass one or both of radiation detection, and electrical property evaluation.

A currently preferred embodiment forms a pipette tip having an elongate body stretching between a proximal end and a distal end with a fluid path through the body extending from the distal end toward the proximal end. The preferred embodiment is structured to permit detection of radiation emitted from an excited, or stimulated, particle of interest that passes through an interrogation zone. In general, an interrogation zone is disposed in proximity to structure configured to urge particles into approximately single-file travel. Optionally, certain embodiments may electrically interrogate fluid flowing along the fluid path. Desirably, embodiments of an operable sensor component are configured and arranged to determine volumetric particle count. Sometimes, the sensor component may be configured and arranged to detect the presence of a fluid boundary edge at one or more particular location along the fluid path. In one such device, the sensor component may be configured and arranged to permit determination of a fluid flow rate along the fluid path.

In some cases, the body is structured to include a plurality of layers configured and arranged to provide at least a portion of the fluid path. In certain such cases, a workable sensor component can be formed by part of a first electrically conductive trace carried between first and second adjacent layers. The first sensor component can be formed by a first stretch of the first trace being disposed to contact fluid flowing along the fluid path. Further, a second electrically conductive trace may be carried between adjacent layers, with at least a stretch of the second trace being disposed to contact fluid flowing along the fluid path as a second sensor component. Sometimes, the first sensor component and the second sensor component may be spaced apart along the fluid path and carried between the same layers. Other times, the first sensor component and the second sensor component are spaced apart along the fluid path and carried between different layers. A plurality of such sensor components may be provided at a plurality of desired locations, as desired.

In certain embodiments, part of the fluid path is defined by a length of lumen encompassing a known volume between distinct points. Further, sensor components can be disposed at such distinct points effective to indicate travel through the pipette tip of an amount of fluid comprising a sample volume corresponding to that known volume. Time of flight for the fluid front between sensor components that are spaced apart along a fluid channel having known volume there-between may be used to determine volumetric flow rate of an interrogated sample.

A pipette tip structured in accordance with certain principles of the instant invention may be used to advantage in combination with a pipette that is configured and arranged to couple with the proximal end of the pipette tip. Desirably, coupling the tip to the pipette is effective to orient an interrogation zone to permit application of excitation radiation to the zone, and detection of emission radiation from the zone, as well as to permit application of suction to a proximal portion of the fluid path. Furthermore, it is sometimes desirable for the act of coupling the tip and pipette to place a sensor component in-circuit with electrical interrogation apparatus.

Some embodiments may include structure adapted to permit detection of a pipette tip when the tip is installed in a pipette. Different pipette tips may be structured to have different detectable identities, e.g. different resistance values caused between electrical contact pad pins, or different contact pads being disposed in direct electrical communication, which can be used as triggers, which, for example, may be used to perform particular tests depending upon the obtained tip identity.

A device may be used by coupling a pipette tip structured according to certain principles of the instant invention to a cooperatingly structured pipette effective to place the pipette tip into position for interrogation of particles passing through an interrogation zone of the tip by interrogation apparatus, and to place a proximal end of the fluid path through the tip in communication with a suction source. Then, a fluid-motive pressure is applied effective to draw a sample into the pipette tip. At least a portion of the sample is interrogated as that portion flows along the fluid path and past the sensor component. Data collected by the sensor component may be shown on a display screen associated with the pipette, and/or transferred to a computer, or other data collection device, for further analysis or storage. Subsequent to completion of fluid sample analysis, the used pipette tip is discarded.

A preferred method of applying suction encompasses generating an excess suction pressure that may then be down-regulated by structure associated with the pipette effective to apply: i) a first suction pressure operable to draw a sample into the pipette tip; and ii) a subsequent desired suction pressure profile over time.

These features, advantages, and alternative aspects of the present invention will be apparent to those skilled in the art from a consideration of the following detailed description taken in combination with the accompanying drawings.

### BRIEF DESCRIPTION OF THE DRAWINGS

In the drawings, which illustrate what are currently considered to be the best modes for carrying out the invention:

FIG. 1 is a schematic of a cross-section taken through a first embodiment illustrating general principles of operation of the invention;

FIG. 1A is a plot illustrating frequency vs radiation wavelength;

FIG. 2 is a cross-section in elevation illustrating certain details of a workable plumbing arrangement that may be associated with certain structure of an interrogation platform;

FIG. 3 is a top view of the plumbing arrangement illustrated in FIG. 2;

FIG. 4 is a cross-section in elevation illustrating certain details of another workable plumbing arrangement associated with certain structure of an interrogation platform;

FIG. 5 is a view in elevation of a currently preferred arrangement for certain structure of an operable interrogation platform;

FIG. 6 is a view in perspective of an assembled pipette tip structured to interrogate particles entrained in a fluid flowing therethrough and to permit detection of fluorescence of certain such particles;

FIG. 7 is a top view of the pipette tip of FIG. 6, with the top two layers removed;

FIG. 8 is an exploded assembly top view in perspective of the pipette tip of FIG. 6;

FIG. 9 is an exploded assembly bottom view in perspective of the pipette tip of FIG. 8;

FIG. 10 is a cross-section through a device structured according to certain principles if the instant invention;

FIG. 11 is a view in perspective of a pipette structured as an interrogation platform for use with a pipette tip such as the tip illustrated in FIG. 6;

FIG. 12 is a close-up side view of a tip-interface portion of the pipette illustrated FIG. 11, partially in section; and

FIG. 13 is a view in perspective of an interrogation component arrangement for a pipette tip.

### MODES FOR CARRYING OUT THE INVENTION

Reference will now be made to the drawings in which the various elements of the invention will be given numerical designations and in which the invention will be discussed so as to enable one skilled in the art to make and use the invention. It is to be understood that the following description is only exemplary of the principles of the present invention, and should not be viewed as narrowing the claims which follow.

As typically used in this disclosure, and unless otherwise obvious in context, the term “fluid” may include a liquid alone, one or more liquids in a mixture, or one or more liquid and particles entrained or suspended therein. In certain cases, a fluid will have electrolytic properties. A bulk fluid container is simply a container sized to hold an amount of fluid sufficient to form at least one fluid sample to be interrogated with an embodiment of the instant device.

The term “particle” and its variants, is intended to encompass a small piece of matter, nonexclusively including a live or dead biological cell, and a molecule. Unless otherwise apparent in context, “pressure” and “suction” is generally intended to be measured with respect to local atmospheric pressure.

By “controlled radiation interrogation zone” it is meant that at least an operable measure of control is exerted over the travel of particles of interest in the zone. An operable level of control physically organizes particles into an arrangement sufficient to permit detecting emitted radiation effective to distinguish, or quantify, individual particles of interest traveling through the controlled radiation interrogation zone. Such control is in stark contrast to uncontrolled radiation, such as would be the case of excitation radiation impinged into a test tube containing a plurality of particles of interest. In such case, the Stokes-shift radiation emitted from a particle might be detected, but would be uncontrolled, and one could not distinguish, or quantify, individual particles of interest. One could extract only the limited information that there are at least some particles of interest in the test tube.

An orifice may be defined broadly to encompass any sort of constricting structure effective to organize or arrange particles of interest into a desirably compact cross-section as such particles travel through a portion of a pipette tip. In one currently preferred embodiment, an orifice is essentially a hole-through-a-plate. Desirably, the particles of interest are urged for travel in at least approximately single-file order by structure of the orifice.

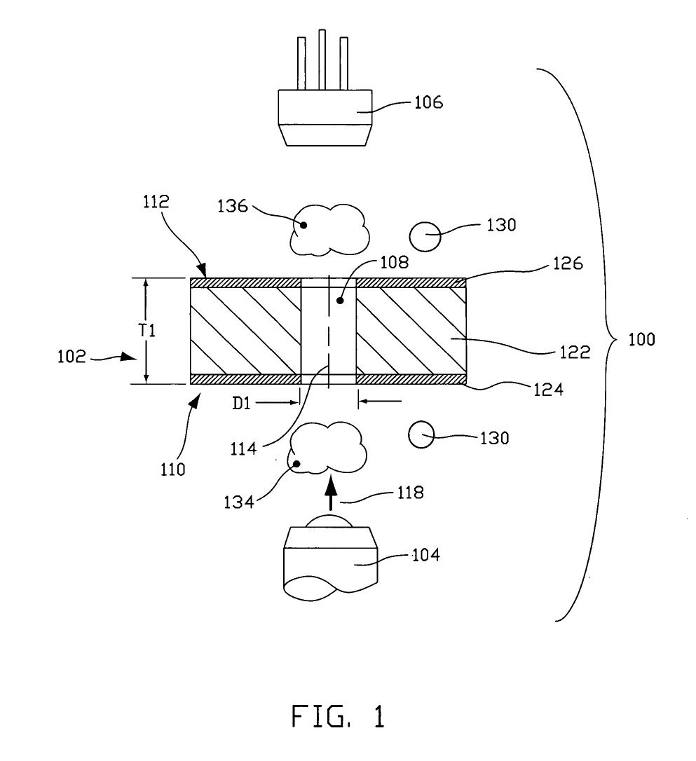

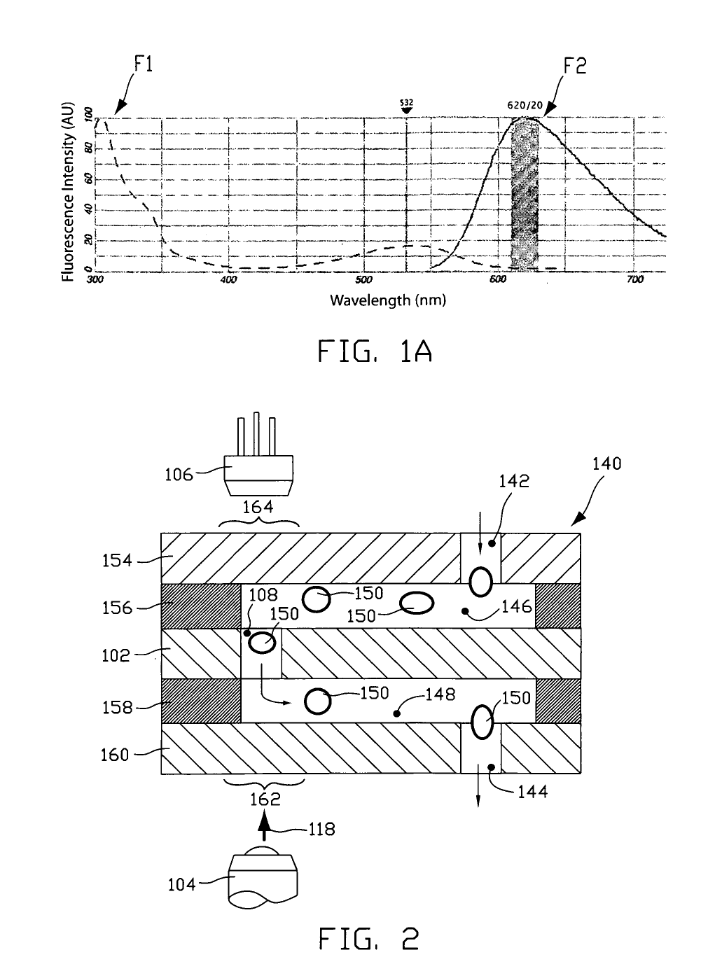

A schematic illustrating a generalized operable arrangement of structure employed in certain embodiments of the invention is indicated generally at 100 in FIG. 1. As illustrated, embodiment 100 includes an opaque member, generally indicated at 102, disposed between a radiation source 104 and a radiation detector 106. Sometimes, opaque member 102 may be made reference to as an interrogation layer, because layer 102 is associated with an interrogation zone. At least one orifice 108 is disposed in opaque member 102 to provide a flow path between a first side, generally indicated at 110, and a second side, generally indicated at 112. Orifice 108 may be characterized as having a through-axis 114 along which fluid may flow between the first and second sides 110 and 112 of opaque member 102, respectively.

The thickness, T1, of an opaque member and characteristic size, D1, of an orifice are typically sized in agreement with a size of a particle of interest to promote single-file travel of the particle through the opaque member, and to have substantially only one particle inside the orifice at a time. In the case where the apparatus is used to interrogate blood cells, the thickness of the opaque member may typically range between about 10 microns and about 300 microns, with a thickness of about 125 microns being currently preferred. The diameter, or other characteristic size of the orifice, may range between about 5 and 200 microns, with a diameter of about 50 microns being currently preferred.

An operable opaque member 102 may function, in part, to reduce the quantity of primary radiation 118 (or sometimes, excitation radiation) that is emitted by source 104, which is received and detected by radiation detector 106. Primary radiation 118 is illustrated as a vector having a direction. Desirably, substantially all of the primary radiation 118 is prevented from being detected by the radiation detector 106. In any case, operable embodiments are structured to resist saturation of the detector 106 by primary radiation 118. As illustrated in the arrangement depicted in FIG. 1, primary radiation 118 may simply pass through orifice 108 for reception by the radiation detector 106. Therefore, as will be further detailed below, certain embodiments may employ one or more selective radiation filters as a measure to control radiation received by detector 106, or alternatively, direct primary radiation 118 at an angle with respect to the detector 106.

The opaque member 102 illustrated in FIG. 1 includes a core element 122, carrying a first coating 124 disposed on first side 110, and a second coating 126 disposed on second side 112. An alternative core element may be formed from a core element having a coating on a single side. The illustrated coatings 124, 126 cooperatively form a barrier to transmission of excitation radiation through the core element 122. Of course, it is also within contemplation to alternatively use a bare core element that is, itself, inherently resistant to transmission of radiation. One currently preferred core includes opaque polyamide film that transmits very little light through the film, so no metallizing, or other barrier element, is required. However, certain embodiments may even have an interrogation layer 102 that is substantially transparent to primary radiation 118.

A workable core 122 for use in detecting small sized particles can be formed from a thin polymer film, such as PET having a thickness of about 0.005 inches. Such polymer material is substantially permeable to radiation, so one or more coatings, such as either or both of coating 124 and 126, can be applied to such core material, if desired. A workable coating includes a metal or alloy of metals that can be applied as a thin layer, such as by sputtering, vapor deposition, or other well-known technique. Ideally, such a layer should be at least about 2-times as thick as the wavelength of the primary radiation, e.g. about 1 μm in one operable embodiment. The resulting metallized film may be essentially impervious to transmission of radiation, except where interrupted by an orifice. Aluminum is one metal suitable for application on a core 122 as a coating 124 and/or 126.

The apparatus 100 is configured to urge a plurality of particles 130 in substantially single-file through orifice 108. A particle 130 typically passes through an excitation zone as the particle approaches, passes through, and departs from the orifice 108. Of note, the direction of particle-bearing fluid flow may be in either direction through orifice 108. An excitation zone typically includes the through-channel defined by orifice 108. An excitation zone may also include a volume indicated by lower cloud 134, which encompasses a volume in which a particle may reside and be in contact with primary radiation. An excitation zone may further include a volume indicated by upper cloud 136, which also encompasses a volume in which a particle may reside and be in contact with primary radiation.

In certain cases, e.g. where there may be a plurality of orifices, the term “zone” may include a plurality of such distributed zones. That is, it is within contemplation to perform interrogation in a plurality of hydraulically parallel zones. However, the appropriate meaning of the term “zone” is believed to be aduceable in context. In the excitation zone, primary radiation 108 impinged upon particles causes certain particles to fluoresce (undergo a Stokes-shift), thereby emitting radiation at a different wavelength compared to the primary radiation 108 and in substantially all three ordinate directions. The fluorescence radiation emitted by those certain particles is then detected by the radiation detector 106.

It should be noted, for purpose of this disclosure, that the term “wavelength” is typically employed not necessarily with reference only to a single specific wavelength, but rather may encompass a spread of wavelengths grouped about a characteristic, or representative, wavelength. With reference to FIG. 1A, the characteristic wavelength F1 (e.g. excitation wavelength) of the primary radiation 118 is sufficiently different from the characteristic wavelength F2 of the fluorescence (e.g. emission wavelength) to enable differentiation between the two. Furthermore, the difference between such characteristic wavelengths, or Stokes-shift differential, is desirably sufficiently different to enable, in certain embodiments, including a selective-pass filter element between the radiation source 104 and detector 106 effective to block transmission of primary radiation toward the detector, while permitting transmission of the fluorescence through the selective-pass filter to the detector.

With reference again to FIG. 1, the embodiment 100 may essentially be disposed in a suitably sized container that is divided into two portions by the opaque member. Flow of fluid (and particles entrained in that fluid) through the orifice 108 could be controlled by a difference in pressure between the two divided portions. However, it is typically desired to provide more control over the flow path of particles in the vicinity of the orifice 108 than such an embodiment would permit. For example, a clump of particles disposed near an entrance or exit of the orifice 108 could shield a particle of interest from the primary radiation 118 to the extent that fluorescence does not occur, thereby causing a miscount, or preventing detection of such a shielded particle of interest.

The multi-layered embodiment, generally indicated at 140 and illustrated in FIG. 2, provides a plumbing arrangement that is structured to resist particle clumping near the orifice 108, and consequential lack of detection of a particle of interest. Multilayer assembly 140 is structured to urge fluid flow through the orifice 108 in a direction that is essentially orthogonal to fluid flow in channel portions adjacent to, and upstream and downstream of, the orifice 108. Such fluid flow resists stacking of particles in a thickness direction of the plumbing arrangement 140, and thereby reduces likelihood of undetected particles of interest.

Plumbing arrangement 140 includes five layers configured and arranged to form a channel system effective to direct flow of particle bearing fluid from a supply chamber 142, through orifice 108 in an opaque member 102, and toward a waste chamber 144. Desirably, a depth of fluid guiding channels 146 and 148 are sized in general agreement with a size of a particle 150, to resist “stacking” particles near the orifice 108. Fluid can be moved about on the device 140 by imposing a difference in pressure between chambers 142 and 144, or across orifice 108 disposed in opaque member 102. For example, a positive pressure may be applied to the supply chamber 142. Alternatively, a negative pressure may be applied to the waste chamber 144. Both positive and negative pressures may be applied, in certain cases. Alternative fluid motive elements, such as one or more pumps, may be employed to control particle travel through opaque member 102.

Although both of supply chamber 142 and waste chamber 144 are illustrated as being open to the atmosphere, it is within contemplation for one or both to be arranged to substantially contain the fluid sample within a plumbing device that includes a multilayer element 104. Also of note, although a top-down fluid flow is illustrated in FIG. 2, fluid flow may be established in either direction through orifice 108. In one reverse-flow configuration, the positions of supply chamber 142 and waste chamber 144 would simply be reversed from their illustrated positions. In an alternative reverse-flow arrangement, the positions of the radiation source 104 and detector 106 would be reversed from their illustrated positions.

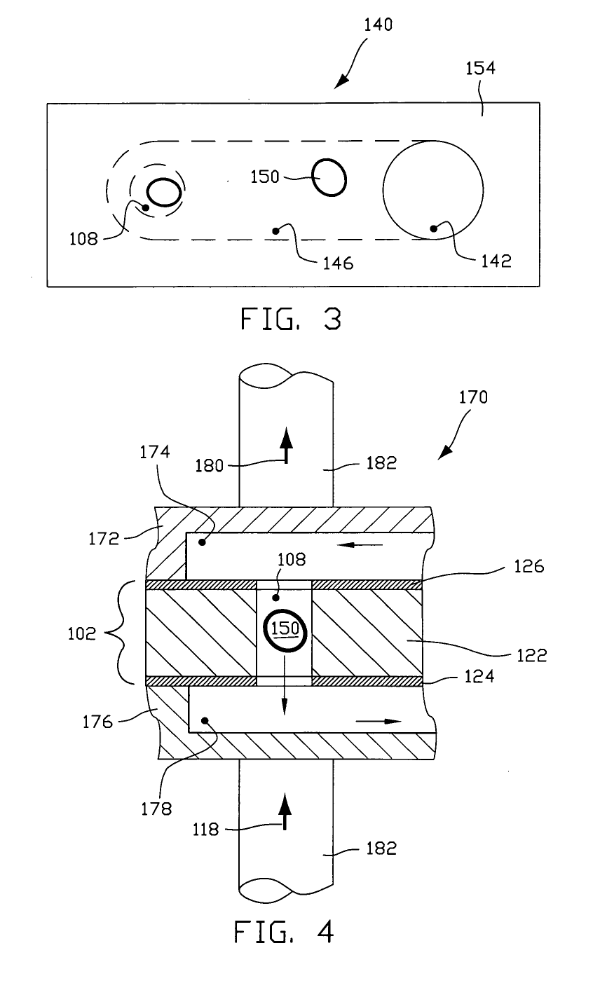

The multilayer plumbing arrangement 140 illustrated in FIGS. 2 and 3 includes a top cap layer 154, a top channel layer 156, an opaque member 102, a bottom channel layer 158, and a bottom cap layer 160. Such layers can be stamped, e.g. die cut, or manufactured by using a laser or water jet, or other machining technique, such as micro machining, etching, and the like. In a currently preferred embodiment 140 that is used to interrogate blood cells, certain of the various layers are typically made from thin polymer films, which are then bonded together to form the multilayer assembly. Desirably, the thickness of at least the channel layers 156, 158 are on the order of the characteristic size of particles of interest to promote single-file travel of particles through an interrogation zone. A workable thickness of such layers in currently preferred devices used to interrogate blood cells typically ranges between about 10 microns and about 300 microns.

In any case, at least a portion of bottom layer 160 is adapted to form a bottom window 162, through which excitation radiation 118 may be transmitted into an excitation zone. Similarly, top layer 154 includes a portion forming a window 164, through which fluorescence may be transmitted. Therefore, the assembly 140 is arranged to form a window permitting radiation to pass through its thickness. Such window includes window portions 162, 164, certain portions of channels 146 and 148 disposed in the vicinity of orifice 108, and the orifice 108 itself. Radiation can therefore be directed through the thickness of the assembly 140 in the vicinity of the orifice 108.

The plumbing arrangement illustrated in FIG. 4, and generally indicated at 170, includes a top layer 172, which carries a carved-out fluid-flow channel 174. Bottom cap layer 176 similarly includes a carved-out channel 178. Opaque member 102 is adapted to dispose orifice 108 for fluid communication between channels 174 and 178. Bottom layer 176 is formed from a material that permits transmission of radiation in an appropriate spectrum to enable excitation of particles, which pass through an excitation zone associated with the orifice 108, by primary radiation 118. Top layer 172 is formed from a material that permits transmission of radiation in an appropriate spectrum to enable transmission of fluorescence 180 toward a radiation detector. Top layer 172 may also be adapted to resist transmission of primary radiation 118. Again, the fluid and particle flow may be in a direction reversed from that illustrated.

As illustrated in FIG. 4, sometimes a plumbing arrangement, such as arrangement 170, may be coupled to, or associated with, a radiation source and/or a radiation detector by way of a fiber optic cable 182. A fiber optic cable 182 may be disposed to operate as a lens effective to capture a substantial portion of fluorescence transmitted through the plumbing arrangement 170. Alternatively, the fiber optic element may simply pipe radiation toward, or away from, the excitation zone to permit disposition of a source, or a detector, at a desired distance away from the excitation zone.

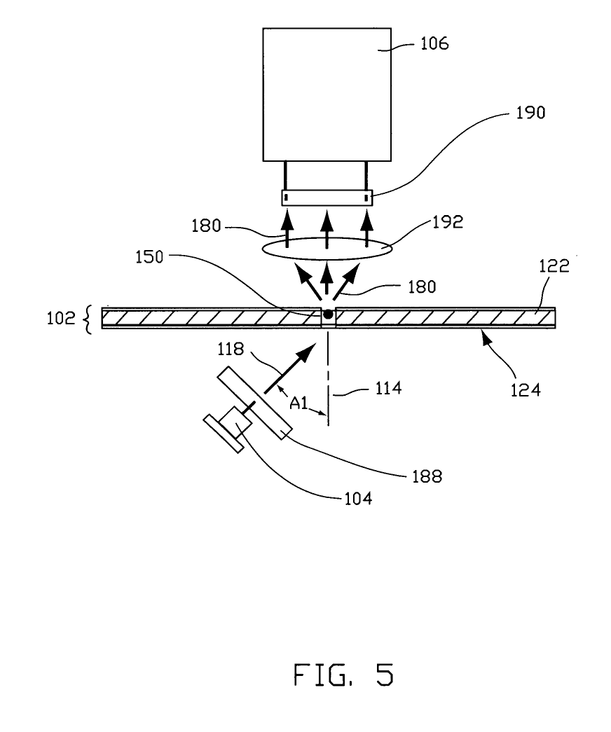

Because fluorescence propagates from a tagged and excited particle of interest in substantially all directions, the primary radiation 118 may be directed to an excitation zone from a side, instead of only from directly below such zone. With reference now to FIG. 5, sometimes it is preferred to apply primary radiation 118 at an acute angle A1 to axis 114 of orifice 108. In such case, the opaque member 102 may even function substantially as an operable filter to resist direct transmission of primary radiation 118 to a radiation detector. As illustrated, radiation vector 118 can be oriented to pass through, or partially into, orifice 108 without being detected by radiation detector 106. However, when a tagged particle 150 is present in an excitation zone (such as orifice 108 as illustrated), the resulting fluorescence 180 may still be detected by the radiation detector 106. While a workable angle A1 may be between 0 and 90 degrees, it is currently preferred for angle A1 to be between about 15 and about 75 degrees.

A radiation source 104 may be formed from a broad spectrum radiation emitter, such as a white light source. In such case, it is typically preferred to include a pre-filter 188 adapted to pass, or transmit, radiation only in a relatively narrow band encompassing the characteristic value required to excite a particular fluorescing agent associated with a particle of interest. It is generally a good idea to limit the quantity of applied radiation 118 that is outside the excitation wavelength to reduce likelihood of undesired saturation of the radiation detector, and consequent inability to detect particles of interest.

In one embodiment adapted to interrogate blood cells, it is currently preferred to use a red diode laser, and to include a short pass filter (after the diode laser) that passes primary light radiation with wavelengths shorter than about 642 nm. It is also currently preferred to include a band pass filter (prior to the photodetector) with a peak that matches a particular selected fluorescence peak. Commercially available dyes may be obtained having characteristic fluorescent peaks at 660, 694, 725, and 775 nanometers. Long pass filters are also often used in place of band-pass filters prior to the photodetector. The pipette tip “cap layer” and “substrate” can also be designed to act as optical filters to aid or eliminate the need for the traditional excitation and emission filters. In this disclosure, “Post filter” may more conventionally be referred to as an “emission filter”.

With continued reference to FIG. 5, sometimes it is preferred to include a post filter 190 that resists transmission of radiation outside the characteristic wavelength of the fluorescence 180. Such an arrangement reduces background noise and helps to avoid false readings indicative of presence of a particle of interest in an excitation zone. Also, to assist in obtaining a strong signal, an optical enhancement, such as a lens 192, can be included to gather fluorescence 180 and direct such radiation toward the radiation detector 106. Illustrated lens 192 may be characterized as an aspheric collecting lens (or doublet), and typically is disposed to focus on a point located inside the orifice 108.

It is within contemplation that a device structured according to certain principles of the instant invention may, or may not, include one or more sensor component, such as an electrode, disposed in various patterns, and at various places, for contact with the fluid flowing through a conduit in the device, e.g. for impedance-based particle interrogation. Selected operable arrangements of such interrogation structure is disclosed in U.S. patent application Ser. No. 11/800,167, titled “THIN FILM PARTICLE SENSOR, and filed on May 4, 2007, the entire contents of which are hereby incorporated as though set forth herein in its entirety.

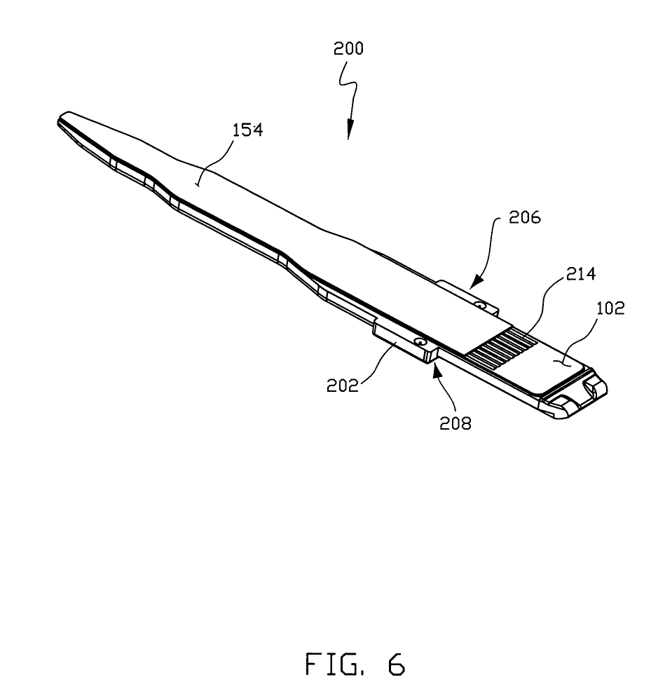

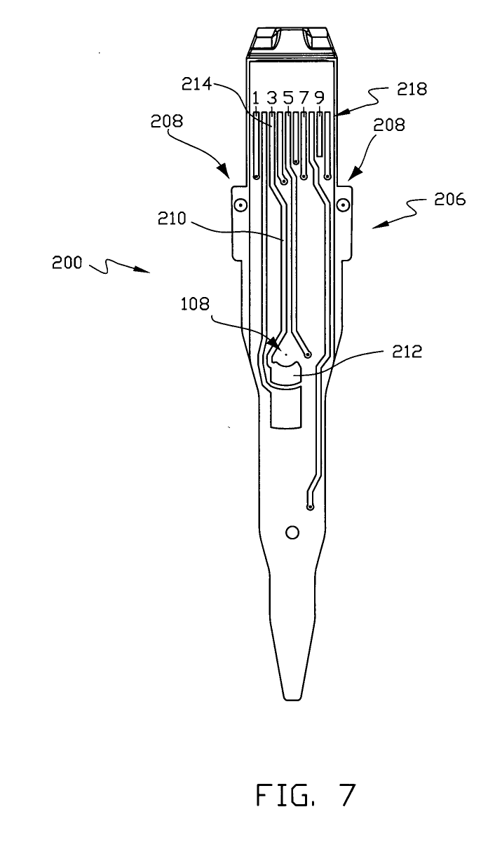

FIGS. 6-9 illustrate details of construction of a currently preferred embodiment structured according to certain principles of the instant invention. The embodiment is a pipette tip, generally 200, that is disposable after a single use, although in certain cases the tip 200 may be used more than once. Pipette tip 200 is formed from a plurality of thin polymer film layers carried on an injection molded substrate 202. In FIG. 7, the top cap layer 154 and top channel layer 156 are omitted, for additional clarity.

With reference to FIG. 6, transversely protruding wing structure can be provided to form a grip area, generally 206, effective to assist in installing a tip 200 into a pipette. As illustrated, the proximal end of grip area 206 may be configured to form a shoulder, generally 208, effective to limit an insertion depth to promote consistent seated engagement of the tip 200 inside the pipette's receiving socket.

Certain components that are operable to construct an apparatus according to certain principles of the instant invention are commercially available. For example, one operable source of radiation 104 includes a red diode laser available under part number VPSL-0639-035-x-5-B, from Blue Sky Research, having a place of business located at 1537 Centre Point Drive, Milpitas, CA 95035. Filter elements 188, 190 are avilable from Omega Optical, having a place of business located at 21 Omega Dr., Delta Campus, Brattleboro, Vt. 05301. Preferred filters include part numbers, 660NB5 (Bandpass filter), and 640ASP (shortpass filter). An operable radiation detector includes a photomultiplier tube available from the Hamamatsu Corporation, having a place of business located at 360 Foothill Rd., Bridgewater, N.J. 08807, under part number H5784-01. Molecular Probes (a division of Invitrogen Corporation, www.probes.invitrogen.com) supplies a plurality dyes that are suitable for use in tagging certain particles of interest for interrogation using embodiments structured according to the instant invention. In particular, AlexaFluor 647, AlexaFluor 700, and APC-AlexaFluor 750 find application to interrogation of blood cells. These dyes are also commonly used in flow cytometric applications and have specific excitation and emission characteristics. Each dye can be easily conjugated to antibodies for labeling, or tagging, different cell types.

The illustrated pipette tip 200 is operable to interrogate particles using either impedance or fluorescence, or both in combination. The illustrated opaque member 102 (sometimes alternatively called an interrogation layer or sheet) carries electrically conductive traces, e.g. 210 configured to form an electrode sensor component 212 in electrical communication with an electrical contact pad 214 (see FIG. 7) that is adapted to communicate with interrogation circuitry. Such interrogation circuitry may be, for example, included as a portion of a currently preferred pipette, or other interrogation apparatus.

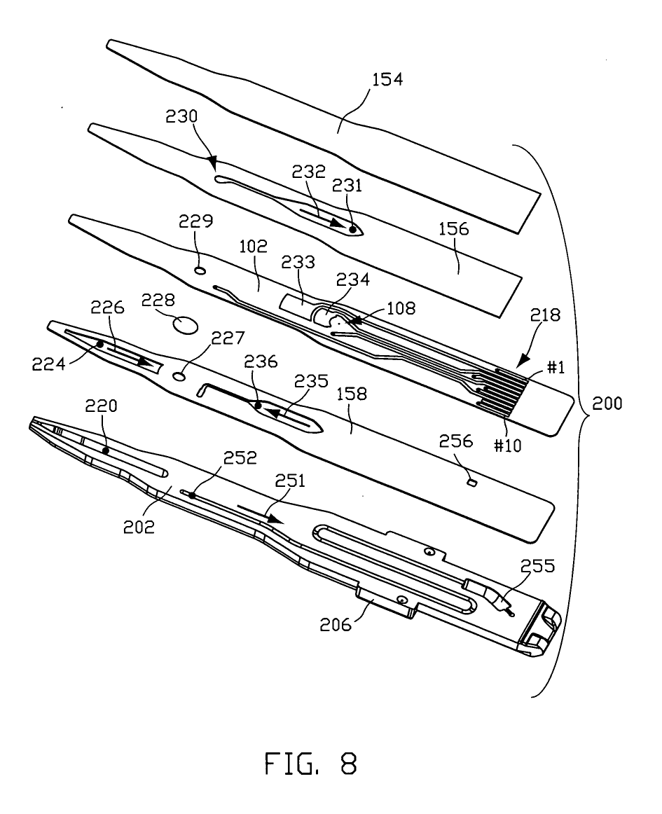

The contact pads illustrated in FIGS. 7 and 8, generally 218, are configured to interface with a commercially available 10-pin edge connector, such as part number SEI-110-02 available from Samtec having a place of business located at SAMTEC USA, P.O. Box 1147, New Albany, IN 47151-1147, and a web site of www.samtec.com. The edge connector may be placed in-circuit with electrical interrogation apparatus in conventional fashion. Other workable connectors include touch-down probes, and other electrically-conductive, contact-forming probes known in the art. Of note, contact pads 214 may be provided on one or both sides of an interrogation layer, such as interrogation layer 102.

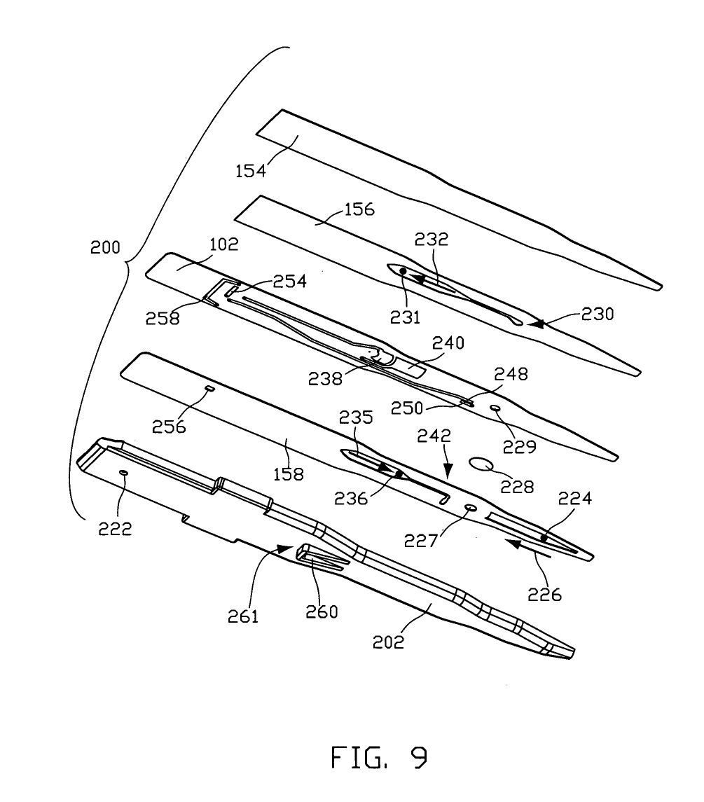

In general, the term “fluid” is used in this disclosure to encompass particles entrained in a fluid. Sometimes, that fluid may be an electrolyte. With reference to FIGS. 8 and 9, fluid is typically drawn into the input reservoir 220 by a suction applied at the fluid exit, or air vent 222. Direction of fluid flow along the reservoir 220, and optional fluid channel 224 formed in the bottom channel sheet 158, is indicated at arrow 226. Fluid channel 224 is desirably included to facilitate visualizing sample fluid flow into a pipette tip, and limit (to the extent possible) exposure of a biological sample to the exposed adhesive. Fluid flow continues transversely through fluid via 227, an optional filter element 228, and fluid via 229, to the distal end 230 of channel 231 in layer 156. Direction of fluid flow in channel 231 is indicated at arrow 232.

Fluid flowing in channel 231 wets a first driving electrode 233 and first interrogation electrode 234, in series. After passing transversely through the orifice 108 in the interrogation sheet 102, fluid then flows along the indicated direction 235 in the channel 236, disposed in the bottom channel sheet 158, and wets second interrogation electrode 238 and second driving electrode 240, in series.

At the distal end 242 of channel 236, fluid wets a first electrode 248 and a second electrode 250, in series. Electrodes 248 and 250 are configured cooperatively to indicate the presence of a fluid front at a known position along the fluid conduit extending proximally from the distal end of the device 200. As illustrated, electrodes 248 and 250 can indicate the arrival of a leading edge of fluid at a known position (essentially at the entrance to the fluid channel 252 disposed in the substrate 202). For example, impedance between electrodes 248 and 250 may be monitored to detect a change from an open-circuit condition. The monitored signal, which shows a discontinuity from an open-circuit value as the fluid boundary wets the second electrode 250, may be used as a trigger signal to start recording or processing data to interrogate fluid as such fluid continues to be inspired into the device 200. An impedance signal between such electrodes may be monitored to detect either a leading or trailing fluid boundary edge. Due to the close proximity of stimulus electrode 248, an electrical signal available at measurement electrode 250 can be monitored for the duration of a test to detect the presence of air bubbles in the sample. Absence of a trailing boundary signal can be used to verify freedom of bubbles in a fluid sample, among other uses.

Interrogation of a fluid sample may be terminated by a subsequent trigger signal that is monitored, for example, to determine completion of interrogation of a known volume of fluid. In the illustrated device 200, after a known volume (downstream of electrode 250, and indicated at arrow 251) has entered the substrate channel 252, the associated fluid front wets a confirmation electrode 254 (see FIG. 9) to signal completion of the test volume. Note that a volume confirmation fluid via 256 extends through bottom channel sheet 158 to permit fluid in channel 252 to wet confirmation electrode 254 when the desired known volume is inspired into the device 200. A trigger signal may be obtained by monitoring the impedance between electrode 254 and either of electrodes 248 or 250, as a non-limiting example. An excess amount of inspired fluid may be contained in storage chamber 255.

A trigger signal from illustrated confirmation electrode 254 may be used to terminate suction applied to air vent 222 to resist potential contamination of a pipette, or other interrogation device, by fluid inspired completely through the device 200. It is also, or alternatively, within contemplation to provide a fluid resistant barrier or membrane (not illustrated) disposed to resist further flow of fluid beyond a desired location in device 200, such as at an exit from storage chamber 255. A workable such barrier permits air molecules to pass, but resists passage of the inspired fluid, to resist drawing inspired fluid into the pipette, or other interrogation device.

Structure to provide a validation signal may be included in a device 200 to confirm proper installation of the pipette tip 200 in a pipette. For example, an electrical continuity signal between electrical contact pad #1 and electrical contact pad #10 may provide the desired feedback. As illustrated in FIG. 9, electrically conductive trace 258 communicates electrically between electrical contact pad #1 and electrical contact pad #10. Proper insertion of the tip 200 into a pipette may therefore generate a desired validation feedback signal (electrical continuity check) between such contact pads.

With reference now to FIG. 9, certain pipette tips 200 may include structure adapted to facilitate removal of in installed pipette tip from a pipette. The illustrated ramp 260 provides a working rear surface, generally 261, against which tip-extracting structure may engage to remove a tip from a pipette.

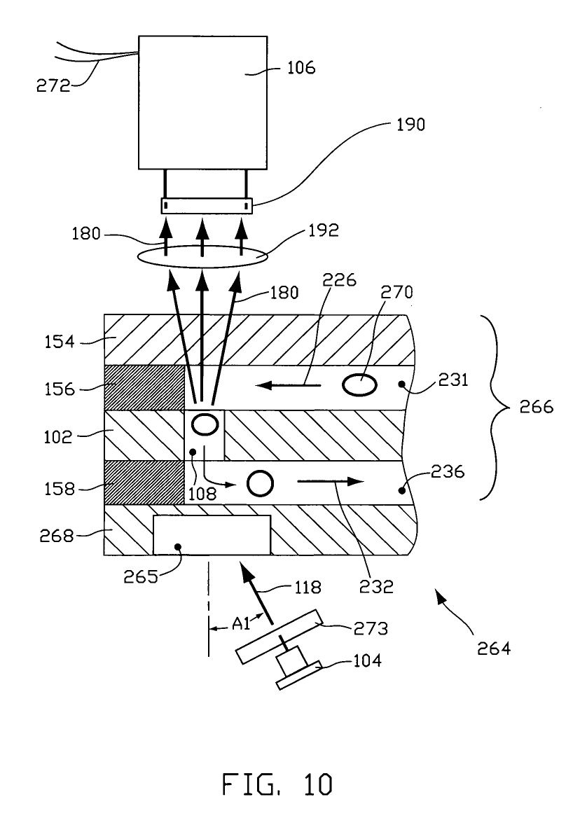

FIG. 10 illustrates a workable arrangement, generally 264, to interrogate particles that undergo a Stokes-shift. Radiation-interrogation arrangement 264 includes a thin film assembly 266 carried on a substrate 268. A currently preferred substrate 268 is injection molded from a polycarbonate material, although other materials are also workable. A substrate 268 desirably is structured to prove sufficient rigidity to an assembly 264 to facilitate material handling.

As illustrated in FIG. 10, a window 265 may be provided to facilitate transmittance of a radiation beam (e.g. a laser beam) for impingement of radiation 118 onto particles located in an interrogation zone associated with the orifice 108. The illustrated window 265 is formed as a socket open to the bottom of the substrate 268, and provides a reduced substrate thickness in the vicinity of the orifice 108. In an alternative arrangement (not illustrated) a thin film window cover may be provided over a window 265 structured as a socket extending through-the-thickness of a substrate.

The thin film assembly 266 illustrated in FIG. 10 includes: top cap sheet 154; top channel sheet 156; opaque member 102; and bottom channel sheet 158. Desirably, top channel sheet 156 and bottom channel sheet 158 are formed from sheets of substantially planar material having a thickness such that fluid guiding channel 231 and fluid guiding channel 236 are sized to avoid clumping of particles of interest near the aperture 108. A width of such channels (into the page, as-drawn), may also be sized to resist such clumping. Again, it should be noted that the directions of flow 226 and 232 may be reversed from the illustrated directions in an alternative workable arrangement.

It is currently preferred to manufacture a thin film assembly, such as assembly 266 in FIG. 10, from stacked sheets of thin polymer films that are bonded together using known multi-layer construction techniques. Channels for fluid flow through an assembly may be formed with micromachining techniques, laser or water cutting, stamping, or the like. It is currently preferred to form an interrogation aperture 108 by way of a laser drilling operation. Certain layers may carry pre-applied adhesive, or adhesive may be applied between one or more layer. A plurality of component parts, such as conductive trace 210 in FIG. 7, may be distributed over the area of a sheet to form a plurality of assemblies 266 in a group when sheets (typically thin film) are assembled in stacked registration. Desirably, alignment structure is provided in the individual sheets to facilitate stacking in proper registration with adjacent sheets. A plurality of individual assemblies may then be separated from the group assembly.

In an exemplary sensor assembly 266 used in connection with interrogation of blood cells, it is currently preferred to use layers made from Polyamide or Mylar film. A workable range in thickness for Polyamide layers is believed to be about 0.1 micron to about 500 microns. A currently preferred Polyamide cap layer 154 is about 52 microns in thickness. It is currently preferred to make the interrogation layer 102 from Polyamide also. However, alternative materials, such as Polyester film or Kapton, which is less expensive, are also workable. A film thickness of about 125 microns for a channel layer 156, 158 has been found to be workable in a sensor used to interrogate blood cells. Desirably, the thickness of the spacer layer is approximately on the order of the particle size of the dominant particle to be interrogated. A workable range is currently believed to be within about 1 particle size, to about 15 times particle size, or so, although a larger range may also be feasible.

The radiation interrogation assembly 264 in FIG. 10 includes a radiation source 104, such as a laser, which is directed to impinge on particles of interest 270 at a radiation interrogation zone. Radiation 180 emitted by an excited particle in a Stokes-shift transformation may be detected by a radiation detector 106, such as a photo diode. Wires 272 would be connected to the appropriate electrical device of an interrogation circuit in conventional fashion. Desirably, a light enhancing element, such as lens 192, is disposed to collect and focus fluorescence 180 for detection by the detector 106. One or more filter, such as emission filter 192, and/or a pre filter 273 (or excitation radiation filter), may be included in the radiation interrogation assembly. With an appropriate post filter, the excitation radiation 118 may be directed directly through aperture 108 (vs. the illustrated angle of attack A1), without saturating the radiation detector 106.

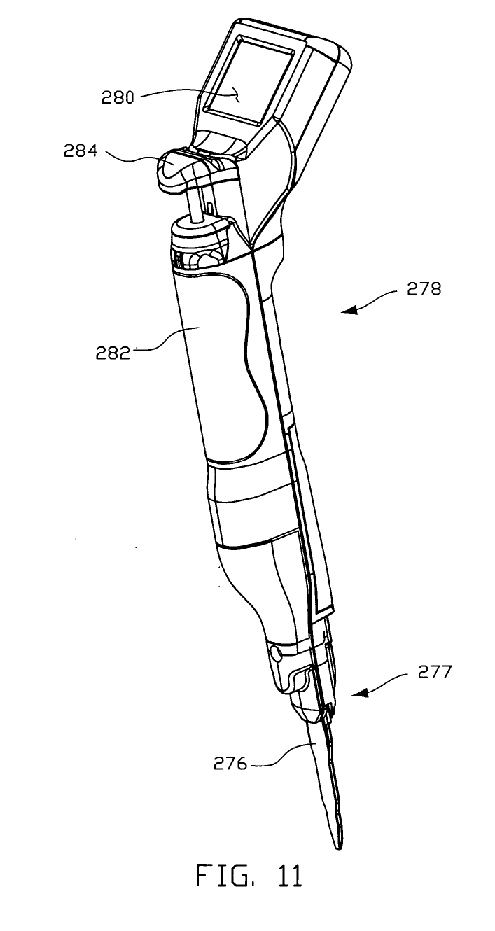

FIG. 11 illustrates a particle interrogating pipette tip 276 installed in a pipette, generally 278, which is structured as an interrogation platform. The proximal end 277 is typically installed into the distal end of the pipette with a slip-fit. A pipette 278 may be structured to interrogate particles, typically carried in an electrolyte fluid, using electrical interrogation, radiation interrogation, or both. Desirably, the interrogation pipette 278 includes a display device, such as screen 280, capable of indicating certain test results, and/or status, such as starting or stopping conditions for a test. A display may be presented in the form of a histogram, numerical value, pie chart, bar chart, and the like. Desirably, the pipette 278 is structured to communicate with a computer to permit uploading interrogation data for storage, and/or additional processing. A user may grasp handle 282 and depress plunger 284 with a thumb to extract a sample from a bulk container.

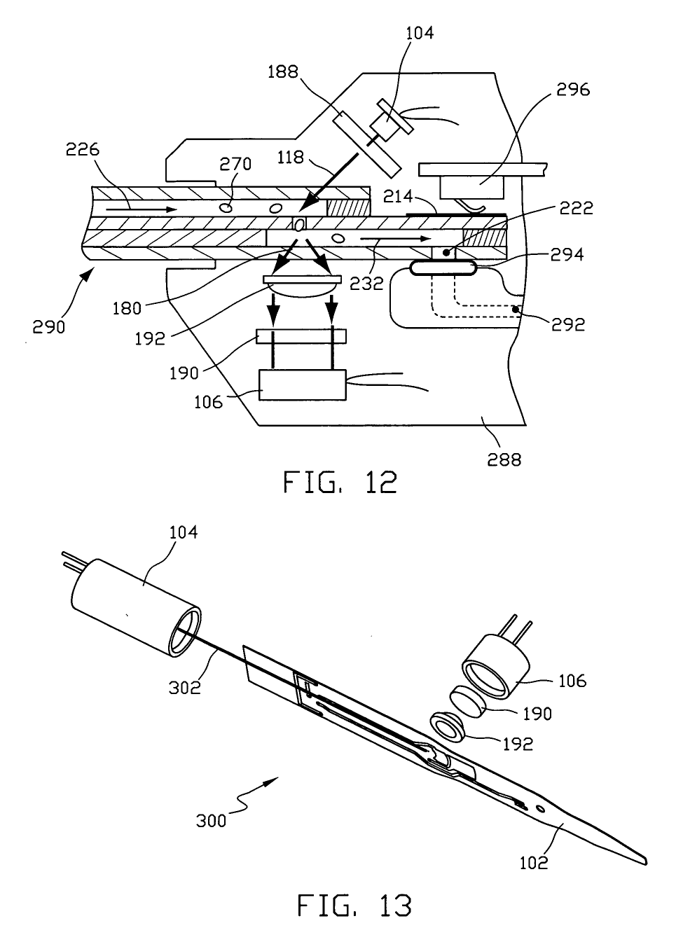

FIG. 12 illustrates certain structure of a workable pipette 288 arranged for interrogating particles in a pipette tip, such as tip 290. Pipette 288 is adapted for interrogation using fluorescence, and/or electrical impedance. Fluid is inspired into the tip 290 by a reduced pressure, or suction, applied by pipette 288 through lumen 292. O-ring 294 forms a sealed joint between tip 290 and lumen 292 to permit communication with air vent 222. An edge connector 296 is desirably included in certain pipettes 288 to couple electrical interrogation circuitry (that is desirably carried within the pipette), with sensor components carried on a pipette tip by way of contact with one or more contact pad 214, if such contact pad is present on the installed pipette tip.

Interrogation structure may be arranged in alternative ways, e.g. fiber optic cable may be incorporated to transmit radiation from a more remote source 104 toward an interrogation zone. Such an arrangement may permit construction of the distal portion of the pipette 288 to present a more slim form factor. Similarly, such cable may be employed in alternative devices to transmit radiation from the interrogation zone to a remotely disposed radiation detector 106.

FIG. 13 illustrates a partially assembled fragment of a pipette tip providing an alternative radiation interrogation arrangement, generally indicated at 300. Radiation interrogation arrangement 300 includes a “pigtail” diode laser 104 (desirably contained in a pipette) that has a short segment of fiber extending toward where the pipette tip will engage. The disposable pipette tip will have its own fiber 302 (or light pipe) that “butt couples” to the fiber in the pipette when the pipette tip is inserted. The fiber 302 in the disposable pipette tip will be sandwiched between layers of laminate.

The fiber 302 (or light pipe) in the pipette tip will deliver the laser light directly to the vicinity of the detection orifice 108 and shine straight across the orifice 108, essentially transverse to the direction of fluid flow in the orifice 108. Particles (or cells) will flow through this light path as they travel into (or out of) the detection orifice 108. Because the excitation radiation 118 is emitted in a direction substantially parallel to the interrogation layer 102, the transversely located detector 106 is out of the path of such radiation. Therefore, layer 102 may even be formed from a material that is entirely permeable to excitation radiation. Radiation emitted (in all directions) from particles undergoing a Stokes-shift will still be detected by detector 106. Again, a lens 192 and/or a filter 190 may be included, as desired.

Devices structured according to certain principles of the instant invention may be employed in a method for interrogating one or more particle. To use the device in one such method, a user would be provided with a device structured to urge particles, entrained in a fluid flowing through a radiation interrogation zone of the device, toward substantially single-file travel to permit detection of emission radiation that is emitted by a particle undergoing a Stokes-shift in that radiation interrogation zone. The user would use the device to extract a fluid sample from a bulk container of fluid. Then excitation radiation, comprising a first characteristic wavelength, would be impinged into the radiation interrogation zone as a portion of the fluid sample flows therethrough. Radiation having a second characteristic wavelength, corresponding to emission radiation from a particle undergoing a Stokes-shift, would be detected effective to gain information about the particle.

In one use of the device, the pipette tip 276 is inserted into the distal end of a pipette 278 to form an air tight seal for air vent 228 and to establish the necessary alignment between the disposable fluorescence-sensing pipette tip and the pipette optics. Next, the plunger 284 is depressed to draw up an excess volume of the sample to be analyzed from a bulk fluid container. This sample will typically be stored in the input reservoir 220 prior to analysis, although simultaneous analysis is possible. Then, the plunger 284 is released, and/or a second button or other control may be actuated, to start the cell counting or interrogation. A controlled vacuum profile will desirably be applied to the sensor/pipette tip 276 to draw cells through the fluorescence detection zone. Single or multiple color fluorescence detection methods could be incorporated. Fluorescent particles are detected and counted. In general, a fixed volume of fluid is interrogated. This may be done optically or using multiple electrodes and electric impedance. This enables volumetric cell counts to be performed. Analytical results may be displayed on a small screen 280, typically in the form of a histogram or scatter plot. Finally, the pipette tip is discarded.

A preferred method of applying suction encompasses generating an excess suction pressure that may then be down-regulated by structure associated with the pipette effective to apply: i) a first suction pressure operable to draw a sample into the pipette tip; and ii) a subsequent desired suction pressure profile over time to cause a desired fluid flow through the sensor portion of the pipette tip.

Embodiments structured according to certain principles of the instant invention may be used to: count particles; verify sample integrity (e.g. freedom from bubbles); estimate or monitor sample flow rate; confirm an inspired volume; determine cellular viability of individual cells in a liquid suspension of known volume; identify/detect specific cells stained with fluorescent dyes (i.e., antibody-conjugated dyes); and determine the presence of a fluorescent analyte or molecule in a liquid suspension of known volume, among other uses.

While the invention has been described in particular with reference to certain illustrated embodiments, such is not intended to limit the scope of the invention. The present invention may be embodied in other specific forms without departing from its spirit or essential characteristics. For non-limiting examples, a layer may have a non-flat conformation, and may only extend along only a portion of the length of a pipette tip. The described embodiments are to be considered only as illustrative and not restrictive. The scope of the invention is, therefore, indicated by the appended claims rather than by the foregoing description. All changes which come within the meaning and range of equivalency of the claims are to be embraced within their scope.

1. In a pipette tip of the type that may be coupled to a pipette to extract a fluid sample from a container of fluid by inspiring the fluid sample into a conduit stretching from a distal end toward a proximal end of the pipette tip, the improvement comprising:
fluid guidance structure associated with said conduit and configured and arranged to provide a controlled radiation interrogation zone effective to permit detection of Stokes-shift radiation emitted by one or more particle of interest that is entrained in fluid inspired into said conduit.

2. The improvement according to claim 1, wherein:
said fluid guidance structure comprises an orifice disposed in proximity to said radiation interrogation zone, said orifice being configured to urge particles of interest into at least approximately single-file for travel therethrough.

3. The improvement according to claim 1, wherein:
said fluid guidance structure comprises a barrier that is substantially opaque to excitation radiation, said fluid guidance structure being configured to cause a local change in the direction of fluid-flow through said conduit.

4. The improvement according to claim 3, further comprising:
an orifice configured to urge travel of particles of interest into substantially single-file for travel through said barrier.

5. The improvement according to claim 1, wherein:
said pipette tip comprises a plurality of stacked thin film layers; and
a portion of said conduit is defined by a channel formed in at least one thin film layer, said channel having a length axis along which fluid is constrained to flow in a direction parallel to said at least one layer.

6. The improvement according to claim 5, wherein:
structure associated with one of said layers forms a barrier that is at least substantially opaque to transmission therethrough of excitation radiation.

7. The improvement according to claim 6, further comprising:
a window configured to facilitate transmittance of excitation radiation for impingement of such radiation onto particles located in said radiation interrogation zone.

8. The improvement according to claim 7, wherein:
said window comprises an area of reduced thickness in a substrate on which said stacked thin film layers are carried.

9. The improvement according to claim 1, further comprising:
a first electrical interrogation component disposed to permit electrical interrogation of fluid flowing along said conduit.

10. The improvement according to claim 9, wherein:
said first electrical interrogation component is structured to permit detecting the arrival of a fluid boundary edge at a particular location along said conduit.

11. The improvement according to claim 9, wherein:
said first electrical interrogation component is configured and arranged in harmony with a second electrical interrogation component to permit estimation of a fluid flow rate along said fluid path.

12. The improvement according to claim 9, wherein:
said first electrical interrogation component is configured and arranged in harmony with a second electrical interrogation component to permit verification of passage of a known volume of fluid through an interrogation zone.

13. The improvement according to claim 9, wherein:
said first electrical interrogation component is configured and arranged in harmony with one or more other electrical interrogation component to permit determination of volumetric particle count for one or more particle of interest as fluid is inspired from said bulk container and into said pipette tip.

14. The improvement according to claim 1, wherein:
said pipette tip is elongate along a length axis; and
an air-vent aperture of said conduit is disposed to communicate to said pipette through a surface of said pipette tip, said surface having a normal oriented generally transverse to said length axis.

15. The improvement according to claim 1, further comprising:
a radiation conducting element sandwiched between layers forming said pipette tip and configured and arranged to transport radiation toward said controlled radiation interrogation zone.

16. The improvement according to claim 15, wherein:
said radiation conducting element comprises a fiber optic cable disposed in parallel to an interrogation layer of said pipette tip such that radiation may be discharged from a terminal end of said cable in a direction substantially transverse to a direction of fluid flow through an interrogation orifice in said interrogation layer.

17. The improvement according to claim 1, further comprising:
a hand-held pipette, said hand-held pipette being configured and arranged to couple with said proximal end of said pipette tip effective to:
permit application of suction to a proximal portion of said conduit; and
orient said radiation interrogation zone with respect to a source of radiation such that radiation from said source may impinge upon particles entrained in fluid flowing through said radiation interrogation zone.

18. The improvement according to claim 17, wherein:
said hand-held pipette comprises a radiation source and a cooperatively arranged radiation detector.

19. An apparatus, comprising:
an elongate body stretching between a proximal end and a distal end, said body comprising a plurality of stacked layers;
a lumen in which fluid may flow, said lumen stretching from an opening disposed at said distal end of said body toward said proximal end of said body, a portion of said lumen being defined by a channel disposed in at least one of said layers and configured to cause fluid flow therethrough in a direction parallel to said at least one of said layers, a constriction of said lumen being structured and arranged to urge particles entrained in a fluid flowing therethrough toward substantially single-file travel;
a radiation interrogation zone disposed in operable association with said constriction;
first radiation transmission structure configured to permit transmission of emission radiation, from a particle undergoing a Stokes-shift in said radiation interrogation zone, outside of said body; and
second radiation transmission structure configured to permit excitation radiation to impinge on a particle present in said radiation interrogation zone.

20. A method for interrogating one or more particle, comprising:
providing a disposable device structured to urge particles, entrained in a fluid flowing through a radiation interrogation zone of said device, toward substantially single-file travel to permit detection of emission radiation that is emitted by a particle undergoing a Stokes-shift in said radiation interrogation zone;
using said device to extract a fluid sample from a bulk container of fluid;
impinging excitation radiation, comprising a first characteristic wavelength, into said radiation interrogation zone as a portion of said fluid sample flows therethrough; and
detecting radiation having a second characteristic wavelength, corresponding to said emission radiation, effective to gain information about said particle.

21. The improvement according to claim 1, wherein:
said pipette tip is structured to permit fluorescence-based interrogation of a portion of said fluid sample while said fluid sample is being extracted from said container.
